(19) United States
(12) Patent Application Publication
(10) Pub. No.: US 2011/0069146 A1
(43) Pub. Date: Mar. 24, 2011

(54) SYSTEM AND METHOD FOR PROCESSING IMAGES

(75) Inventors: SHAO-WEN WANG, Tu-Cheng (TW); PI-JYE TSAUR, Tu-Cheng (TW)

(73) Assignee: HON HAI PRECISION INDUSTRY CO., LTD., Tu-Cheng (TW)

(21) Appl. No.: 12/647,406

(22) Filed: Dec. 25, 2009

(30) Foreign Application Priority Data
Sep. 18, 2009 (CN) 200910307273.X

(51) Int. Cl. H04N 7/00

(52) U.S. Cl. 348/36; 348/E07.001

(57) ABSTRACT

A method for processing images of a scene captured by a plurality of video cameras divides a coordinate plane of a scene into a plurality of partitions according to predetermined division points, and identifies information of the images. The method further distinguishes unusable areas of each image according to the information of the image and the division of the coordinate plane of the scene, and marks a character into each pixel point of the unusable areas of each image. The method further compresses each image by deleting the pixel points marked by the character to generate a compressed image, and integrates all compressed images to generate a panoramic image of the scene.

### BACKGROUND

1. Technical Field

Embodiments of the present disclosure generally relate to systems and methods for processing data, and more particularly to a system and a method for processing image data.

2. Description of Related Art

With the development of computer networks and multimedia applications, video technology, that is, digitally capturing, recording, processing, storing, transmitting, and reconstructing a sequence of still images representing motion, has found widespread application. Such video can be seen as made up of a plurality of images.

As is known, when capturing video record, more than one video camera is preferable since the images captured thereby provide a variation in perspectives of the event or footage.

However, the images to be integrated may share area with others. Such redundantly occupied area increases required storage space for the video and occupies undue bandwidth during transmission of the video data.

### BRIEF DESCRIPTION OF THE DRAWINGS

FIG. 1 is a block diagram of one embodiment of a system for processing images.

FIG. 2 is a block diagram illustrating division of a coordinate plane of a scene as processed in the system of FIG. 1.

FIG. 3 is a flowchart of one embodiment of a method for processing images.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

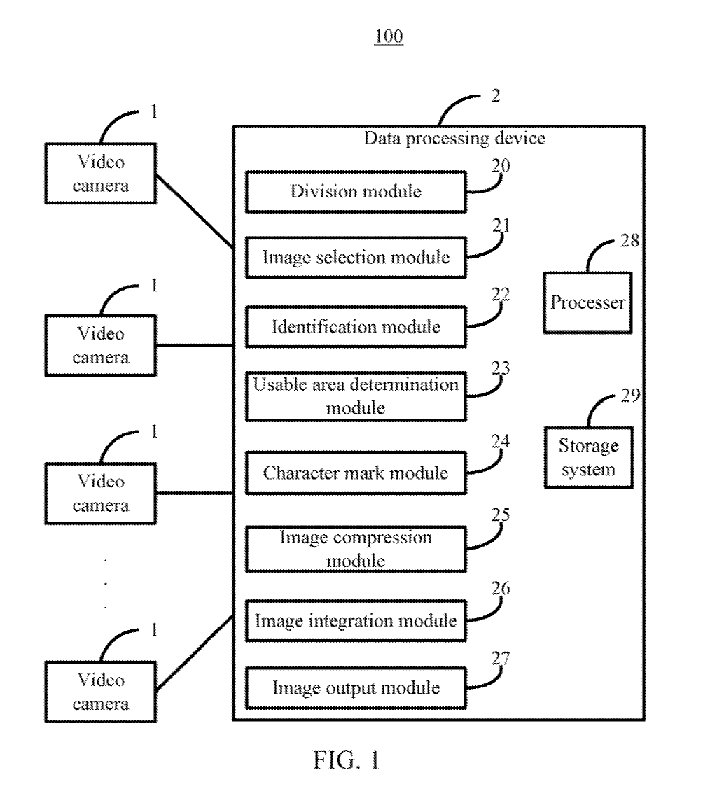

FIG. 1 is a block diagram of one embodiment of a system 100 for processing images. In the present embodiment, the system 100 includes a plurality of video cameras 1 and a data processing device 2. The video cameras 1 may include a first video camera, a second video camera, a third video camera, a fourth video camera, and a fifth camera video, and so forth. The video cameras 1 are placed at different locations of a scene to capture images of the scene from different angles. The data processing device 2 may be a computer, a decoder, or an encoder, for example. The data processing device 2 includes a plurality of function modules (see below description) operable to process the captured images to generate a panoramic image of scene by incorporating all the captured images.

In one embodiment, the function modules of the data processing device 2 may include a division module 20, an image selection module 21, an identification module 22, a usable area determination module 23, a character mark module 24, an image compression module 25, an image integration module 26, and an image output module 27.

In other embodiments, the system 100 may include more than one data processing device 2 in which the function modules 20-27 are distributed. For example, the division module 20, the image selection module 21, the identification module 22, the usable area determination module 23, and the character mark module 24 can be included in an encoder, and the image compression module 25, the image integration module 26, and the image output module 27 in a decoder.

In one embodiment, at least one processor 28 of the data processing device 2 executes one or more computerized codes of the function modules 20-27. The one or more computerized codes of the functional modules 20-27 may be stored in a storage system 29 of the data processing device 2.

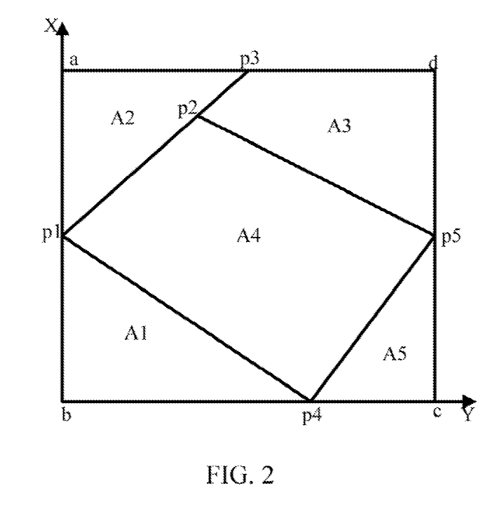

The division module 20 is operable to divide a coordinate plane of the scene into a plurality of partitions according to predetermined division points. In one embodiment, the number of the partitions equals the number of the video cameras 1. An example of such division of the coordinate plane of the scene is illustrated in FIG. 2, where it can be seen that the coordinate plane of the scene, which is represented by characters a, b, c, and d, is divided into five partitions, namely, A1, A2, A3, A4, and A5, according to division points p1˜p5.

The image selection module 21 is operable to select an image from the images captured by the video cameras 1. In one embodiment, the selection may be random.

The identification module 22 is operable to identify information of the selected image. In one embodiment, the information includes the video camera 1 on which the selected image was captured. Here, each image captured by the video cameras 1 bears a mark indicating the video camera 1 on which it was captured.

The usable area determination module 23 is operable to determine a usable area of the selected image according to the information and the division of the coordinate plane of the scene, so as to distinguish unusable areas of the selected image. In one embodiment, the usable areas of images captured by different video cameras 1 are different. In the example of the division of the scene illustrated in FIG. 2, the partition A1 may be the usable area of the image captured by the first video camera, the partition A2 may be the usable area of the image captured by the second video camera, the partition A3 may be the usable area of the image captured by the third video camera, the partition A4 may be the usable area of the image captured by the fourth video camera, and the partition A5 may be the usable area of the image captured by the fifth video camera.

The character mark module 24 is operable to mark a character into each pixel point of the unusable areas of the selected image. The character may be any character.

The image compression module 25 is operable to compress the selected image by deleting the pixel points marked by the character to generate a compressed image.

The image integration module 26 is operable to integrate all the compressed images to generate a panoramic image of the scene.

The image output module 27 is operable to output the panoramic image of the scene.

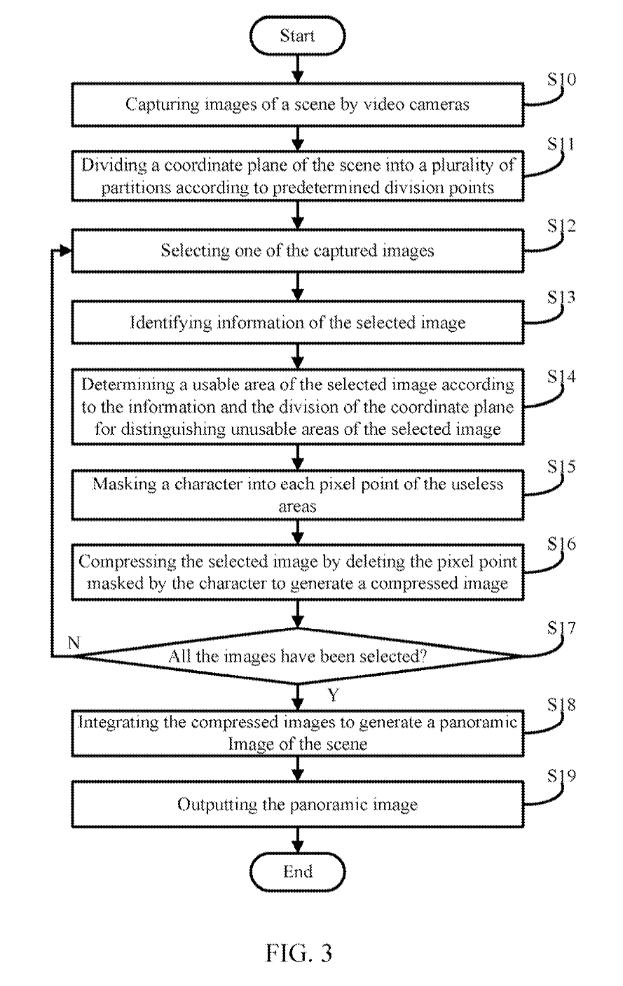

FIG. 3 is a flowchart of one embodiment of a method for processing images. Depending on the embodiment, additional blocks in the flow of FIG. 3 may be added, others removed, and the ordering of the blocks may be changed.

In block S10, the video cameras 1 placed at different locations of a scene capture images of the scene.

In block S11, the division module 20 divides a coordinate plane of the scene into a plurality of partitions according to predetermined division points. In one embodiment, the number of partitions equals the number of the video cameras 1.

In block S12, the image selection module 21 selects an image from the images captured by the video cameras 1. In one embodiment, the selection may be random.

In block S13, the identification module 22 identifies information of the selected image, such as, here, on which video camera the 1 the selected image was captured. In the embodiment, each image captured by the video cameras 1 may includes a mark indicating the video camera 1 on which the image was captured.

In block S14, the usable area determination module 23 determines a usable area of the selected image according to the information and the division of the coordinate plane of the scene for distinguishing unusable areas of the selected image. In one embodiment, the usable areas of the images captured by different video cameras are different.

In block S15, the character mark module 24 marks a character into each pixel point of the unusable areas of the selected image. The character may be any character.

In block S16, the image compression module 25 compresses the selected image by deleting the pixel points marked by the character to generate a compressed image.

In block S17, the image selection module 21 determines if all the images captured by the video cameras 1 have been selected. If at least one image has not been selected, block S12 is repeated. If all the images have been selected, block S18 is implemented.

In block S18, the image integration module 26 integrates all the compressed images to generate a panoramic image of the scene.

In block S19, the image output module 27 outputs the panoramic image of the scene.

Although certain inventive embodiments of the present disclosure have been specifically described, the present disclosure is not to be construed as being limited thereto.

Various changes or modifications may be made to the present disclosure without departing from the scope and spirit of the present disclosure.

What is claimed is:

1. A method for processing images captured by a plurality of video cameras placed at different locations of a scene, the method being performed by execution of computer readable program code by at least one processor of at least one computer system, the method comprising:
(a) dividing a coordinate plane of the scene into a plurality of partitions according to predetermined division points;
(b) selecting an image from the images captured by the video cameras;
(c) identifying information of the selected image, wherein the information comprises identification of the video camera on which the selected image was captured;
(d) determining a usable area of the selected image according to the information and the division of the coordinate plane of the scene for distinguishing unusable areas of the selected image;
(e) marking a character into each pixel point of the unusable areas of the selected image;
(f) compressing the selected image by deleting pixel points marked by the character;
(g) repeating blocks from (b) to (f) until all the images captured by the video cameras have been selected;
(h) integrating all the compressed images to generate a panoramic image of the scene; and
(i) outputting the panoramic image of the scene.

2. The method as described in claim 1, wherein the number of the partitions of the scene equals the number of the video cameras.

3. The method as described in claim 1, wherein each of the images comprises a mark identifying the video camera on which the image was captured.

4. The method as described in claim 1, wherein the usable areas of the images captured by different video cameras are different.

5. A storage medium having stored thereon instructions that, when executed by a processor, cause the processor to perform a method for processing images which are captured by a plurality of video cameras placed at different locations of a scene, wherein the method comprises:
(a) dividing a coordinate plane of the scene into a plurality of partitions according to predetermined division points;
(b) selecting an image from the images captured by the video cameras;
(c) identifying information of the selected image, wherein the information comprises identification of the video camera on which the selected image is captured;
(d) determining a usable area of the selected image according to the information and the division of the coordinate plane of the scene for distinguishing unusable areas of the selected image;
(e) marking a character into each pixel point of the unusable area of the selected image;
(f) compressing the selected image by deleting pixel points marked by the character;
(g) repeating blocks from (b) to (f) until all the images captured by the video cameras have been selected;
(h) integrating all the compressed images to generate a panoramic image of the scene; and
(i) outputting the panoramic image of the scene.

6. The storage medium as described in claim 5, wherein the number of the partitions of the scene equals the number of the video cameras.

7. The storage medium as described in claim 5, wherein each of the images includes a mark identifying the video camera on which the image was captured.

8. The storage medium as described in claim 5, wherein the usable areas of the images captured by different video cameras are different.

9. A system for processing images captured by a plurality of video cameras placed at different locations of a scene, the system comprising:
a scene division module operable to divide a coordinate plane of the scene into a plurality of partitions according to predetermined division points;
an image selection module operable to select an image from the images captured by the video cameras;
an identification module operable to identify information of the selected image, wherein the information comprises identification of the video camera on which the selected image is captured;
a usable area determination module operable to determine a usable area of the selected image according to the information and the division of the coordinate plane of the scene for distinguishing unusable areas of the selected image;
a character mark module operable to mark a character into each pixel point of the unusable areas of the selected image;
an image compression module operable to compress the selected image by deleting pixel points marked by the character;
an image integration module operable to integrate all the compressed images to generate a panoramic image of the scene;
an image output module operable to output the panoramic image of the scene; and
a processor that executes the division module, the image selection module, the identification module, the usable area determination module, the character mark module, the image compression module, the image integration module, and the image output module.

10. The system as described in claim 9, wherein the number of the partitions of the scene equals the number of the video cameras.

11. The system as described in claim 9, wherein each of the images includes a mark identifying the video camera on which the image was captured.

12. The system as described in claim 9, wherein the usable areas of images captured by different video cameras are different.
